(19) United States
(12) Patent Application Publication
(10) Pub. No.: US 2006/0117721 A1
(43) Pub. Date: Jun. 8, 2006

(54) Cyclone dust-separating apparatus

(75) Inventors: Yong-hee Lee, Gwangju-City (KR); Tak-soo Kim, Gwangju-City (KR)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Samsung Gwangju Electronics Co., Ltd.

(21) Appl. No.: 11/087,432

(22) Filed: Mar. 23, 2005

(30) Foreign Application Priority Data
Dec. 2, 2004 (KR) 2004-100259

(51) Int. Cl. B01D 50/00

(52) U.S. Cl. 55/337

(57) ABSTRACT

A cyclone dust-separating apparatus is provided with an improvement on the microscopic dust collection efficiency. The cyclone dust-separating apparatus includes: a cyclone body; and at least one dust separation chamber formed on an inner sidewall of the cyclone body, wherein microscopic dusts are collected at said at least one dust separation chamber.

### CROSS-REFERENCE TO RELATED APPLICATIONS

This application claims the benefit of Korean Patent Application No. 2004-100259 filed on Dec. 2, 2004 in the Korean Intellectual Property Office, the disclosure of which is incorporated herein by reference.

### BACKGROUND OF THE INVENTION

1. Field of the Invention

The present invention relates to a cyclone dust-separating apparatus; and more particularly, to a cyclone dust-separating apparatus for separating dust and air from dust-laden air using centrifugation.

2. Description of the Related Art

Generally, a cyclone dust collecting apparatus revealed in the Korean Laid-Open No. 2002-0091510 issued to M. J. Choi on Dec. 6, 2002, entitled “Cyclone Dust Collecting Apparatus For a Vacuum Cleaner” includes: a cyclone body in which centrifugation and dirt collection take place; an inlet passage formed on a circumferential surface of the cyclone body; and an outlet passage formed on an upper portion of the cyclone body. In the cyclone body, a grill connected with the outlet passage is installed, and a skirt is installed at a bottom portion of the grill.

Under the above configuration, the dust-laden air flowed into the inlet passage is separated into air and dust, and the dust is piled at the bottom of the cyclone body, while the air exhausted out of the cyclone body through the outlet passage.

Meanwhile, the skirt prevents the collected dust precedently separated from the cyclone body from ascending, and the grill prevents dust that is not centrifuged at the cyclone body and dust that detours around the skirt from exhausting out of the outlet passage.

However, although the cyclone dust collecting apparatus is capable of preventing large and small particles of dust from flowing out of the outlet passage in some degrees, the cyclone dust is still limited to prevent those microscopic particulates of dust from exhausting out of the outlet passage. Therefore, the microscopic particulates exhausted without passing through the skirt and the grill clog a motor protection filter and an exhaust filter and as a result, a suction power of a vacuum cleaner becomes weakened.

### SUMMARY OF THE INVENTION

It is, therefore, an aspect of the present invention to provide a cyclone dust-separating apparatus with an improvement on microscopic dust collection efficiency.

It is another aspect of the present invention to provide a cyclone dust-separating apparatus which reduces or eliminates clogging of a filter.

In accordance with one aspect of the present invention, there is provided a cyclone dust-separating apparatus, including: a cyclone body; and at least one dust separation chamber formed on an inner sidewall of the cyclone body, wherein microscopic particulates are collected at the at least one dust separation chamber.

Herein, the at least one dust separation chamber includes a cylindrical wall disposed on the inner sidewall and a bottom surface of the cyclone body. Particularly, an upper part of the cylindrical wall is preferably formed to be inclined in the opposite direction to the rotation direction of airflow within the cyclone body.

Also, the cyclone dust-separating apparatus may further include a plurality of dust separation chambers with individual cylindrical walls formed on the inner sidewall of the cyclone body with different heights and arranged in a sequential order from the lowest height of the dust separation chamber to the highest height of the dust separation chamber along a rotation direction of the airflow within the cyclone body.

In addition, the plurality of dust separation chamber includes: a first dust separation chamber with a first cylindrical wall; a second dust separation chamber with a second cylindrical wall of which height is higher than that of the first cylindrical wall; and a third dust separation chamber with a third cylindrical wall of which height is higher than that of the second cylindrical wall. Preferably, the first to the third dust separation chambers are separated along the apparatus at an angle of approximately 120°.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view showing a cyclone dust-separating apparatus in accordance with a preferred embodiment of the present invention;

FIG. 2 is a diagram showing the cyclone dust-separating apparatus cross-sectioned in a direction of a line II-II illustrated in FIG. 1;

FIG. 3 is a diagram showing the cyclone dust-separating apparatus cross-sectioned in a direction of a line III-III illustrated in FIG. 1;

FIG. 4A is a perspective view showing a first cylindrical wall illustrated in FIG. 3;

FIG. 4B is a perspective view showing a second cylindrical wall illustrated in FIG. 3;

FIG. 4C is a perspective view showing a third cylindrical wall illustrated in FIG. 3; and

FIG. 5 is a development diagram showing main parts of a sidewall of a cyclone body illustrated in FIG. 3.

### DETAILED DESCRIPTION OF THE EXEMPLARY EMBODIMENTS

Certain embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

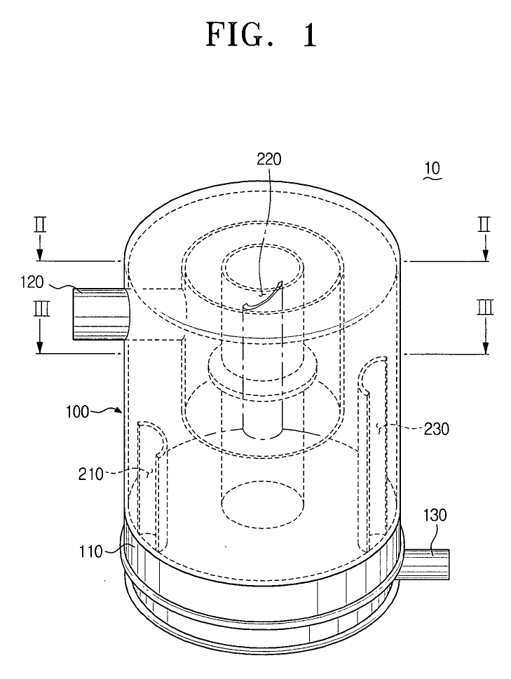

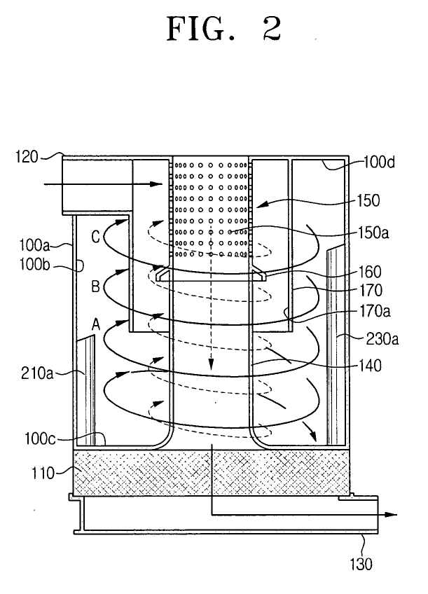

With reference to FIGS. 1 and 2, a cyclone dust-separating apparatus 10 includes a cyclone body 100, a sponge grill 110, a first dust separation chamber 210, a second dust separation chamber 220 and a third dust separation chamber 230.

The cyclone body 100 is a cylindrical container in which dust-laden air is separated into dust and air by the centrifugal force, and the separated dust is simultaneously collected therein. On an outer sidewall 100a of the cyclone body 100, a pipe-type inlet passage 120 for allowing the dust-laden air to be flowed into the cyclone body 100 is formed.

A pipe-type central passage 140 is formed in the inner center of the cyclone body 100 by extending from a bottom surface 100c of the cyclone body 100 to a top surface 100d of the cyclone body 100. A grill 150 is formed on an upper portion of the central passage 140, and at a bottom portion of the grill 150 has a skirt 160 formed in a funnel or funnel-type. The skirt 160 serves a role in impeding the dust-laden air from ascending again, and the grill 150 prevents dust that is not centrifuged and ascending dust that is not captured by the skirt 160 from exhausting out of the outlet passage 130. Also, a plurality of exhaust openings 150a for exhausting air are formed in the grill 150.

Also, in the center of the cyclone body 100, cylindrical-type or annular auxiliary sidewalls 170 are formed with a predetermined length from the top surface 100d of the cyclone body 100 to a bottom surface 100c of the cyclone body 100. In this exemplary embodiment, the auxiliary sidewalls 170 encompass or surround the circumference of the central passage 140 by being spaced apart in a predetermined distance from the central passage 140. Also, one part of the auxiliary sidewalls 170 is connected with the inlet passage 120. A reference numeral 170a denotes an inner surface of the auxiliary sidewall 170.

At a bottom side of the cyclone body 100, the sponge grill 110 for filtering dust in the air passing through the central passage 140 is installed. Also, the outlet passage 130 connected with a driving motor (not shown) for supplying a suction power is disposed beneath the sponge grill 110.

While the exemplary embodiment has the outlet passage 130 at the bottom side of the cyclone body 100 as shown in FIG. 2, alternatively the outlet passage 130 can be positioned in other portions of the cyclone body 100, such as, for example, in an upper portion of the cyclone body, as occasion demands. Also, the auxiliary sidewalls 170 of the cyclone body 100 can be omitted depending on needs.

Meanwhile, there is at least one dust separation chamber 210, 220 or 230 on an inner sidewall 100b of the cyclone body 100 to collect microscopic particulates of dust rotating along the inner sidewalls 100b of the cyclone body 100.

Arrows A, B, and C illustrated in FIGS. 2, 3 and 5 express the flow paths of air with different heights. That is, the height of the air at arrow B is greater than that of the air at arrow A and, is less than that of the air at arrow C. Although there exists numerous flow paths of air in addition to the illustrated airflow, these flow paths of air will be omitted for simplification of the explanation.

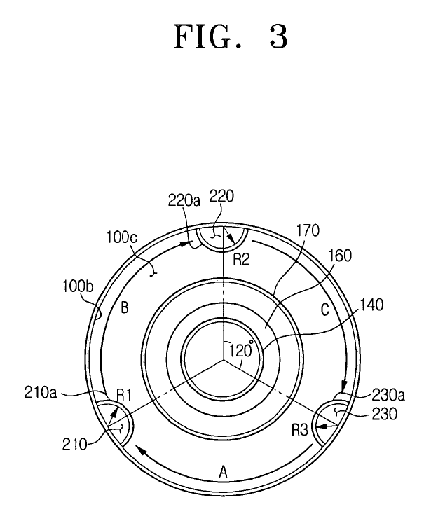

With reference to FIG. 3, there are the first to the third dust separation chambers 210 to 230 in accordance with the preferred embodiment of the present invention. Particularly, the first to the third dust separation chambers 210 to 230 are disposed at angles of approximately 120° to each other along the inner sidewall 100b of the cyclone body 100.

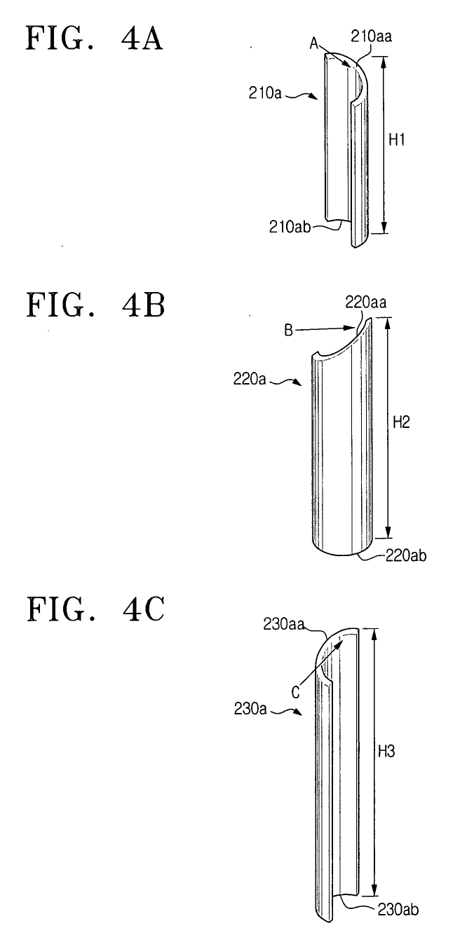

Referring to FIGS. 3, 4A and 5, the first dust separation chamber 210 includes a first cylindrical or arcuate wall 210a disposed on the inner sidewall 100b and the bottom surface 100c of the cyclone body 100. The first cylindrical wall 210a is a semi-circular pipe of which first upper part 210aa and first lower part 210ab are opened and have a first radius of R1 and a first height of H1. When the first cylindrical wall 210a is glued, welded or otherwise connected with the inner sidewall 100b and the bottom surface 100c, the first dust separation chamber 210 is created. The first upper part 210aa of the first cylindrical wall 210a is inclined in a downward direction in an angle of θ1 from a reference horizontal line such that the first upper part 210aa faces in the opposite direction to a rotation direction of the air within the cyclone body 100. Those microscopic particulates of dust rotating along the inner sidewall 100b of the cyclone body 100 at a height of the arrow A hit the first upper part 210aa of the first cylindrical wall 210a and drop down the first dust separation chamber 210.

Referring to FIGS. 3, 4B and 5, the second dust separation chamber 220 includes a second cylindrical or arcuate wall 220a disposed on the inner sidewall 100b and the bottom surface 100c of the cyclone body 100. The second cylindrical wall 220a is a semi-circular pipe of which second upper part 220aa and second lower part 220ab are opened and have a second radius of R2 and a second height of H2. When the second cylindrical wall 220a is glued, welded or otherwise connected with the inner sidewall 100b and the bottom surface 100c of the cyclone body 100, the second dust separation chamber 220 is created. The second upper part 220aa of the second cylindrical wall 220a is inclined in a downward direction in an angle of θ2 from a reference horizontal line such that the second upper part 220aa faces in the opposite direction to a rotation direction of the air within the cyclone body 100. Those microscopic particulates of dust rotating along the inner sidewall 100b of the cyclone body 100 at a height of the arrow B hit the second upper part 220aa of the second cylindrical wall 220a and drop down the second dust separation chamber 220.

With reference to FIGS. 3, 4C and 5, the third dust separation chamber 230 includes a third cylindrical or arcuate wall 230a disposed on the inner sidewall 100b and the bottom surface 100c of the cyclone body 100. The third cylindrical wall 230a is a semi-circular pipe of which third upper part 230aa and third lower part 230ab are opened and have a third radius of R3 and a third height of H3. When the third cylindrical wall 230a is glued, welded or otherwise connected with the inner sidewall 100b and the bottom surface 100c of the cyclone body 100, the third dust separation chamber 230 is created. Especially, the third upper part 230aa of the third cylindrical wall 220a is inclined in a downward direction in an angle of θ3 from a reference horizontal line such that the third upper part 230aa faces in the opposite direction to a rotation direction of the air within the cyclone body 100. Those microscopic particulates of dust rotating along the inner sidewall 100b of the cyclone body 100 at a height of the arrow C hit the third upper part 230aa of the third cylindrical wall 230a and drop down the third dust separation chamber 230.

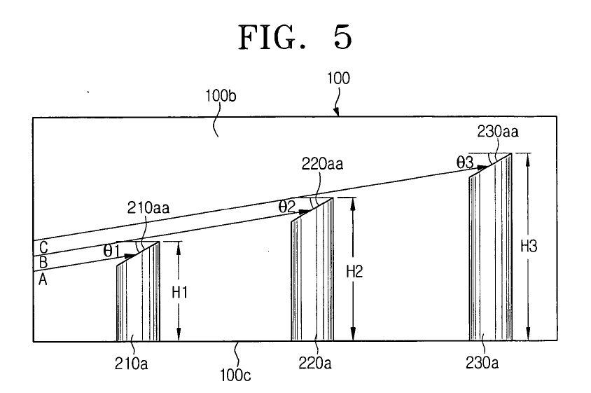

Referring to FIG. 5, the heights of the first to the third cylindrical walls 210a, 220a and 230a, i.e., the first height H1, the second height H2 and the third height H3, are different from each other. That is, the height increases in an ascending order of the first height H1, the second height H2 and the third height H3. Thus, when the first dust separation chamber 210, the second dust separation chamber 220 and the third dust separation chamber 230 are sequentially disposed on the inner sidewall 100b of the cyclone body 100, microscopic particulates of dust that make a helical rotation along the inner sidewall 100b of the cyclone body 100 are first collected at the first dust separation chamber 210, then at the second dust separation chamber 220, and lastly at the third dust separation chamber 230. Therefore, the differentiated heights of the first to the third cylindrical walls 210a to 230a give a higher efficiency in collecting microscopic particulates of dust, in comparison with the first to the third cylindrical walls 210a to 230a being formed with the same height.

In more detail, those microscopic particulates of dust rotating at a height of the arrow A along the inner sidewall 100b of the cyclone body 100 collide with the first upper part 210aa of the first inclined cylindrical wall 210a and drop down the first dust separation chamber 210 thereafter.

Next, those microscopic particulates of dust rotating at a height that allows the microscopic particulates to elude hitting the first upper part 210aa, but are at a height of B along the inner sidewall 100b of the cyclone body 100 collide with the second upper part 220aa of the second inclined cylindrical wall 220a and drop down the second dust separation chamber 220 thereafter.

Afterwards, those microscopic particulates of dust rotating at a height that allows the microscopic particulates to elude hitting the second upper part 220aa and the first upper part 210aa, but are at a height of the arrow C along the inner sidewall 100b of the cyclone body 100 collide with the third upper part 230aa of the third cylindrical wall 230a and drop down the third dust separation chamber 230 thereafter.

As a result of this specific structure, the microscopic particulates of dust in the air rotating helically along the inner sidewall 100b of the cyclone body 100 are sequentially collected at the first dust separation chamber 210, the second dust separation chamber 220 and the third dust separation chamber 230.

As mentioned above, there are numerous flow paths of the air in addition to those airflows illustrated as the arrows A, B and C, and microscopic particulates of dust in that air will be collected at one of the first to the third dust separation chamber 210 to 230 that corresponds to the height of the individual airflow.

Additionally, the present disclosure contemplates other numbers of dust separation chambers for collecting the microscopic particulates of dust, including more than three dust separation chambers, and which can also be equidistantly disposed about the inner sidewall 100b of the cyclone body 100. The more dust separation chambers being used, the higher the efficiency on the collection of microscopic particulates. However, the increased number of dust separation chambers results in a more complicated structure of the cyclone body 100, which further brings out an increase in manufacturing costs and complication in manufacturing processes. Therefore, it is preferred that three dust separation chambers, i.e., the first to the third dust separation chamber 210 to 230, are disposed on the inner sidewall 100b of the cyclone body 100 at an angle of approximately 120° with respect to each other.

Hereinafter, operation of the cyclone dust-separating apparatus 10 with the above-described configuration will be described in detail.

Referring to FIGS. 2, 3 and 5, dust-laden air flowing into the auxiliary sidewalls 170 through the inlet passage 120 descends by making a helical rotation. At this time, those large and small particles of the dust-laden air move towards the inner surface 170a of the auxiliary sidewall 170 and the inner sidewall 100b of the cyclone body 100 due to the centrifugal force and then are collected at the bottom surface 100c of the cyclone body 100. Concurrently, those microscopic particulates of dust that still rotate around the inner sidewall 100b of the cyclone body 100 are sequentially collected at the first to the third dust separation chambers 210 to 230.

That is, the microscopic particulates of dust rotating at a height of the arrow A are collected primarily at the first dust separation chamber 210, and those microscopic particulates of dust rotating at a height of the arrow B and at a height of the arrow C are collected at the second dust separation chamber 220 and at the third dust separation chamber 230, respectively. Since the detailed method for collecting the microscopic particulates are identical to the above, description on the collection method will be omitted. On the basis of this identified dust separation method, it is possible to prevent microscopic particulates of dust from directly exhausting out of the outlet passage 130.

Meanwhile, when the ascending airflow, the descending air flow and the airflow of the cyclone body 100 become unstable because of external environmental changes, some collected dust at the bottom surface 100c of the cyclone body 100 ascends, and at this time, those large and small particles of the dust are prevented from exhausting out of the outlet passage 130 because of the grill 150 and the skirt 160. Those microscopic particulates of dust that are not captured by the grill 150 and the skirt 160 are collected again at the first to the third dust separation chamber 210 to 230. Accordingly, unlike the conventional dust collecting apparatus, the microscopic dusts are not allowed to directly exhaust out of the outlet passage 130. Afterwards, the air separated from large, small and microscopic particulates of dust exhaust out of the cyclone dust-separating apparatus 10 through the outlet passage 130.

In accordance with the preferred embodiment of the present invention, the cyclone dust-separating apparatus includes a number of dust separation chambers capable of collecting even microscopic particulates of dust by being formed on the inner sidewall of the cyclone body. These dust separation chambers provide at least the following effects. First, there is an improvement on the microscopic dust collection efficiency. Second, it is possible to decrease the frequency that microscopic particulates of dust clog a motor protection filter and an exhaust filter. Third, it is further possible to prevent occurrence of weakened suction power of a vacuum cleaner caused by clogged filters.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A cyclone dust-separating apparatus, comprising:
a cyclone body; and
at least one dust separation chamber formed on an inner sidewall of the cyclone body, wherein microscopic particulates of dust are collected at the dust separation chamber.

2. The cyclone dust-separating apparatus of claim 1, wherein the at least one dust separation chamber comprises a cylindrical wall disposed on the inner sidewall of the cyclone body, wherein the cylindrical wall has an upper opening that is inclined in an opposite direction to a direction of rotation of airflow within the cyclone body.

3. The cyclone dust-separating apparatus of claim 2, wherein the at least one dust separation chamber is a plurality of dust separation chambers, each of the plurality of dust separation chambers having cylindrical walls on the inner sidewall of the cyclone body of different heights, wherein the plurality of dust separation chambers are arranged in a sequential order from a lowest height to a highest height along a direction of rotation of the airflow within the cyclone body.

4. The cyclone dust-separating apparatus of claim 3, wherein the plurality of dust separation chambers comprises:
a first dust separation chamber with a first cylindrical wall having a first height;
a second dust separation chamber with a second cylindrical wall having a second height that is higher than the first height of the first cylindrical wall; and
a third dust separation chamber with a third cylindrical wall having a third height that is higher than the second height of the second cylindrical wall.

5. The cyclone dust-separating apparatus of claim 4, wherein the first, second and third dust separation chambers are disposed at an angle of approximately 120° with respect to each other along the inner sidewall of the cyclone body.

6. The cyclone dust-separating apparatus of claim 2, further comprising:
an inlet passage that supplies the airflow to the cyclone body;
an outlet passage that exhausts the airflow from the cyclone body; and
a central passage in fluid communication with the inlet and outlet passages and disposed in the cyclone body, wherein the central passage has a grill that prevents the dust from exhausting out of the outlet passage.

7. The cyclone dust-separating apparatus of claim 6, wherein the central passage has a skirt that impedes the dust from ascending towards the grill.

8. The cyclone dust-separating apparatus of claim 6, further comprising an annular wall that partially surrounds the central passage, wherein the annular wall is connected with the inlet passage to allow airflow between the annular wall and the central passage.

9. A vacuum cleaner comprising:
a vacuum source; and
a cyclone body in fluid communication with the vacuum source and having an inner sidewall with at least one dust separation chamber, wherein microscopic particulates of dust are collected at the dust separation chamber.

10. The cleaner of claim 9, wherein the at least one dust separation chamber comprises a cylindrical wall disposed on the inner sidewall of the cyclone body, wherein the cylindrical wall has an upper opening that is inclined in an opposite direction to a direction of rotation of airflow within the cyclone body.

11. The cleaner of claim 9, wherein the at least one dust separation chamber is a plurality of dust separation chambers, each of the plurality of dust separation chambers having cylindrical walls on the inner sidewall of the cyclone body of different heights, wherein the plurality of dust separation chambers are arranged in a sequential order from a lowest height to a highest height along a direction of rotation of the airflow within the cyclone body.

12. The cleaner of claim 11, wherein each of the plurality of dust separation chambers has an upper opening that is inclined in an opposite direction to a direction of rotation of airflow within the cyclone body.

13. The cleaner of claim 9, wherein the plurality of dust separation chambers comprises:
a first dust separation chamber with a first cylindrical wall having a first height;
a second dust separation chamber with a second cylindrical wall having a second height that is higher than the first height of the first cylindrical wall; and
a third dust separation chamber with a third cylindrical wall having a third height that is higher than the second height of the second cylindrical wall.

14. The cleaner of claim 13, wherein the first, second and third dust separation chambers are disposed at an angle of approximately 120° with respect to each other along the inner sidewall of the cyclone body.

15. The cleaner of claim 10, further comprising:
an inlet passage that supplies the airflow to the cyclone body;
an outlet passage that exhausts the airflow from the cyclone body; and
a central passage in fluid communication with the inlet and outlet passages and disposed in the cyclone body, wherein the central passage has a grill that prevents the dust from exhausting out of the outlet passage.

16. The cleaner of claim 15, wherein the central passage has a skirt that impedes dust from ascending towards the grill.

17. The cleaner of claim 15, further comprising an annular wall that partially surrounds the central passage, wherein the annular wall is connected with the inlet passage to allow airflow between the annular wall and the central passage.

18. A method of separating microscopic particulates of dust from air comprising:
supplying air from a source into a cyclone body;
guiding the air thereby forming a helical airflow path in the cyclone body;
moving the dust in the air towards an inner sidewall of the cyclone body due to centrifugal force; and
collecting microscopic particulates of the dust using at least one dust separation chamber disposed along the inner sidewall, wherein the microscopic particulates of dust flow through an inclined opening of the at least one dust separation chamber and fall into the dust separation chamber.

19. The method of claim 18, further comprising collecting the microscopic particulates with a plurality of dust separation chambers disposed along the inner sidewalls by varying a position of each of the inclined openings of the plurality of dust separation chambers with respect to the height of the cyclone body.

20. The method of claim 18, further comprising equidistantly spacing each of the plurality of dust separation chambers about the inner sidewall of the cyclone body.
